(19) United States
(12) Patent Application Publication
(10) Pub. No.: US 2025/0306352 A1
(43) Pub. Date: Oct. 2, 2025

(54) OPTICAL SYSTEM TO REORIENT A MAJOR DIMENSION OF A MICROSCOPE’S FIELD OF VIEW

(71) Applicant: VIAVI Solutions Inc., Chandler, AZ (US)

(72) Inventors: Kevin CASSADY, Monroe, WA (US); Jay Gregory BRACE, Lynnwood, WA (US); Andrew PARSONS, Brier, WA (US)

(21) Appl. No.: 19/086,427

(22) Filed: Mar. 21, 2025

Related U.S. Application Data
(60) Provisional application No. 63/571,772, filed on Mar. 29, 2024.

(51) Int. Cl. G02B 21/02; G02B 21/00

(52) U.S. Cl. CPC G02B 21/02; G02B 21/0016

(57) ABSTRACT

An optical tip includes an optical system that includes a set of optical components. The optical tip is configured to interface with a device that includes a microscope that is configured to inspect an optical connector attached to an optical cable. The set of optical components are configured to reorient a first major dimension of a field of view of the microscope of the device to not align with a second major dimension of a sensor of the device.

### CROSS-REFERENCE TO RELATED APPLICATION

This patent application claims priority U.S. Provisional Patent Application No. 63/571,772, filed on Mar. 29, 2024, and entitled “OPTICAL SYSTEM TO REORIENT A MICROSCOPE'S FIELD OF VIEW.” The disclosure of the prior application is considered part of and is incorporated by reference into this patent application.

### BACKGROUND

A microscope may include an instrument used to see objects that are too small to be seen by the naked eye. Microscopy may include investigating small objects and structures using a microscope. A microscope may be used to view and inspect an end face of an optical fiber.

### SUMMARY

In some implementations, a device for inspecting an optical connector attached to an optical cable includes a microscope configured to inspect at least one region of interest (ROI) of the optical connector; and an optical system configured to be positioned between the microscope and the at least one ROI of the optical connector, the optical system including a set of optical components, wherein: the microscope is configured to have a field of view (FOV) with a first major dimension that is aligned with a second major dimension of a sensor of the microscope; and the set of optical components are configured to, when the microscope inspects the at least one ROI, reorient the first major dimension of the FOV to align with a longest dimension associated with the at least one ROI that is not aligned with the second major dimension of the sensor.

In some implementations, a device for inspecting an optical connector attached to an optical cable includes a microscope; and an optical system that includes a set of optical components, wherein: the microscope is configured to have an FOV with a first major dimension that is aligned with a second major dimension of a sensor of the microscope; and the set of optical components are configured to reorient the first major dimension of the FOV to not align with the second major dimension of the sensor.

In some implementations, an optical tip includes an optical system that includes a set of optical components, wherein: the optical tip is configured to interface with a device that includes a microscope that is configured to inspect an optical connector attached to an optical cable; and the set of optical components are configured to reorient a first major dimension of an FOV of the microscope of the device to not align with a second major dimension of a sensor of the device.

### BRIEF DESCRIPTION OF THE DRAWINGS

FIGS. 1A-1B are diagrams of one or more example implementations described herein.

FIGS. 2A-2B are diagrams of one or more example implementations described herein.

FIGS. 3A-3D are diagrams of one or more example implementations described herein.

FIGS. 4A-4C are diagrams of one or more example implementations described herein.

FIGS. 5A-5B are diagrams of one or more example implementations described herein.

FIGS. 6A-6B are diagrams of one or more example implementations described herein.

FIGS. 7A-7B are diagrams of one or more example implementations described herein.

### DETAILED DESCRIPTION

The following detailed description of example implementations refers to the accompanying drawings. The same reference numbers in different drawings may identify the same or similar elements.

A technician can use a device, such as a handheld optical fiber microscope, to inspect an end face of an optical fiber of an optical cable prior to connecting the optical cable to network equipment. The device can include a microscope (e.g., a video microscope) and should be positioned to allow the end face of the optical fiber to be placed in a field of view (FOV) of the microscope. This enables the device to capture images (e.g., as individual images or a stream of images) of an end face of the optical fiber so that the device (and/or another device) can analyze the images for dirt particles, dust particles, scratches, and/or other surface defects. The device may need to capture a high-quality image of the end face of the optical fiber in order to perform an accurate analysis of the end face. For example, in order to enable an accurate analysis of the end face, the end face should be fully within the FOV of the microscope so that any dirt particles, dust particles, scratches, fingerprints, debris, and/or other surface defects are able to be detected when the image of the end face is analyzed.

In many cases, a microscope (e.g., a video microscope) has an FOV that is greater in a first dimension (e.g., a horizontal dimension) than a second dimension (e.g., a vertical dimension), also referred to a major dimension. Additionally, in some cases, the FOV can be extended by panning the microscope (or the device that includes the microscope). However, panning is typically restricted to only a single direction (e.g., that is associated with one of the first dimension or the second dimension).

In some field applications (e.g., in some practical use applications), a device under test (DUT) (e.g., an optical connector that includes an end face of an optical fiber within the optical connector) is positioned and/or oriented such that a region of interest (ROI) of the DUT (e.g., an opening of the optical connector that exposes the end face of the optical fiber) is not fully within the FOV of the microscope of the device. This is often because a dimension (e.g., a longest dimension, such as a horizontal dimension) of the ROI of the DUT is not aligned with the major dimension of the FOV of the microscope (e.g., the horizontal dimension of the ROI of the DUT is not aligned with a horizontal dimension of the FOV of the microscope). Further, many factors, such as ergonomics (e.g., manual characteristics of a technician that limit the technician's ability to adjust a position and orientation of the device or the microscope), physical interference (e.g., that physically constrains adjustment of a position and orientation of the device or the microscope), or other factors, can prevent the microscope, or the device, from being adjusted to align the FOV with the ROI of the DUT. Consequently, accurate imaging and analysis of the ROI of the DUT is difficult, or, impossible.

In some cases, the device can be designed to allow panning of the microscope in multiple directions to allow the FOV of the microscope to be extended in multiple directions, or the microscope can be custom-designed to have an extended FOV in one or more directions. However, this adds a complexity to the design, manufacture, and maintenance of the device and/or microscope, and can be cumbersome or impractical to use.

Some implementations include an optical system (e.g., an optical assembly, an optical sub-assembly, or another type of optical system). The optical system may be configured to be included in an optical tip that interfaces with a microscope of a device that is configured to inspect at least one ROI of a DUT, such as of an optical connector. The optical system may be configured to be positioned such that the optical system is between the microscope and the ROI of the DUT (e.g., when the device is used to inspect the ROI of the DUT).

The optical system includes one or more optical components (e.g., mirrors, prisms, or other optical components). The optical components of the optical system are configured to reorient the major dimension of the FOV of the microscope. That is, the set of optical components are configured to reorient the major dimension of the FOV to not align with (e.g., to not be parallel to) a major dimension of a sensor of the microscope. Accordingly, the set of optical components are configured to, when the microscope inspects the ROI of the DUT, reorient the major dimension of the FOV to align with the longest dimension associated with the ROI of the DUT. In this way, the set of optical components enable imaging (e.g., simultaneous imaging) of the entire ROI as a result of the ROI being within the FOV of the microscope (e.g., as reoriented by the set of optical components).

In this way, the optical system enables alignment of the FOV of the microscope and the ROI of the DUT when such alignment would otherwise not be possible (e.g., due to ergonomics, physical interference, or other factors) for a device that does not utilize the optical system. In this way, the optical system enables accurate imaging and analysis of the ROI of the DUT than would otherwise be possible.

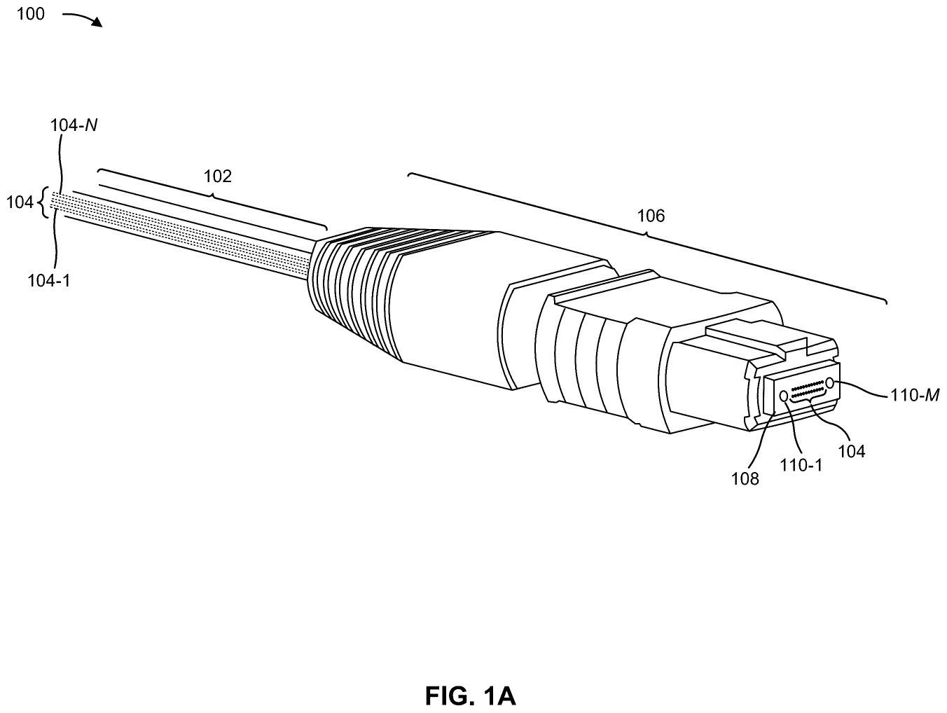

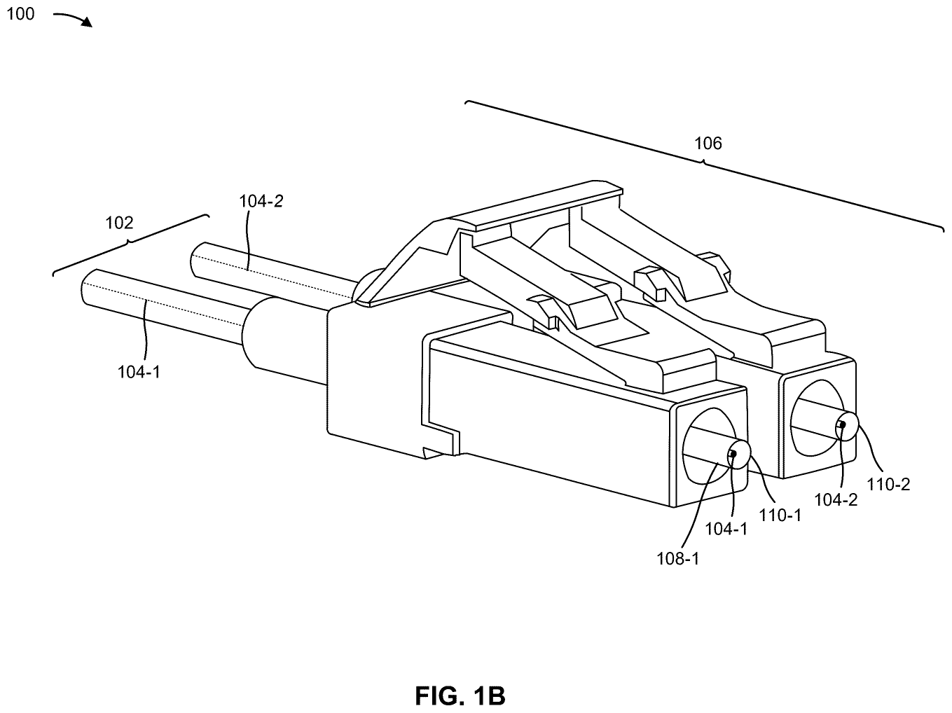

FIGS. 1A-1B are diagrams of one or more example implementations 100 described herein. As shown in FIGS. 1A-1B, example implementation(s) 100 include an optical cable 102, a set of one or more optical fibers 104 (shown, via dashed lines, as optical fibers 104-1 through 104-N, where N≥1, in FIG. 1A, and optical fibers 104-1 and 104-2 in FIG. 1B), and an optical connector 106.

The optical cable 102 may include the set of one or more optical fibers 104 (e.g., within the optical cable 102). For example, an optical fiber 104 may be disposed within a central region of the optical cable 102, along a length of the optical cable 102. As another example, the optical cable 102 may include a plurality of optical fibers 104 arranged in an optical fiber package that is disposed within the central region of the optical cable 102, along the length of the optical cable 102. The plurality of optical fibers 104 may be arranged, for example, in a one-dimensional array or a two-dimensional array within the optical fiber package (e.g., in a cross-section view of the optical fiber package). In some implementations, the optical cable 102 may include at least one ferrule comprising metal, ceramic, high-quality plastic, and/or the like, and each ferrule may have a hollowed-out center that holds and/or grips the set of one or more optical fibers 104. Thus, an optical cable 102, as used herein, may also include multiple individual optical cables 102, such as multiple optical cables 102 that connect to a single optical connector 106.

The optical connector 106 may be attached to the optical cable 102. For example, the optical connector 106 may be connected to an end surface of the optical cable 102. The optical connector 106 may include any type of fiber optic connector, such as a fiber-optic connector (FC), an FC/physical content (PC) connector, an FC/angled physical content (APC) connector, a snap-in connector (SC), a straight tip (ST) connector, a multiple fiber push-on/pull-off (MPO) connector, and/or a little connector (LC) duplex connector, among other examples. FIG. 1A shows the optical connector 106 as an MPO connector, FIG. 1B shows the optical connector 106 as an LC duplex connector.

The set of one or more optical fibers 104 of the optical cable 102 may extend from the end surface of the optical cable 102 and into the optical connector 106. For example, each optical fiber 104 may extend into and terminate within the optical connector 106, with an end face that is exposed within the optical connector 106. The end face may be angled (e.g., at a non-zero angle to a longitudinal axis of the optical fiber 104). The end face may be, for example, polished at a precise angle, such as eight degrees (e.g., within a tolerance of 1 degree). In some implementations, the optical connector 106 may include a single ferrule 108 (e.g., comprising metal, ceramic, high-quality plastic, and/or the like) that holds and/or grips the set of one or more optical fibers 104, as shown in FIG. 1A. Alternatively, as shown in FIG. 1B, the optical connector 106 may include a plurality of ferrules 108 (shown as ferrules 108-1 and 108-2), wherein each ferrule 108 holds and/or grips a subset of the set of one or more optical fibers 104 (shown as optical fibers 104-1 and 104-2).

In some implementations, the optical connector 106 may include one or more structural features 110. For example, as shown in FIGS. 1A-1B, the optical connector 106 may include one or more structural features 110-1 through 110-M, where M≥1. A structural feature 110 may include, for example, an attachment component of the optical connector 106 (e.g., a pin or a hole, such as to facilitate alignment of the optical connector 106 with another optical connector 106 during connection of the two optical connectors 106), or an edge of a ferrule 108 of the optical connector 106 (e.g., as shown in FIG. 1B), among other examples.

As indicated above, FIGS. 1A-1B are provided as one or more examples. Other examples may differ from what is described with regard to FIGS. 1A-1B. In practice, there may be additional components, fewer components, different components, or differently arranged components than those shown in FIGS. 1A-1B.

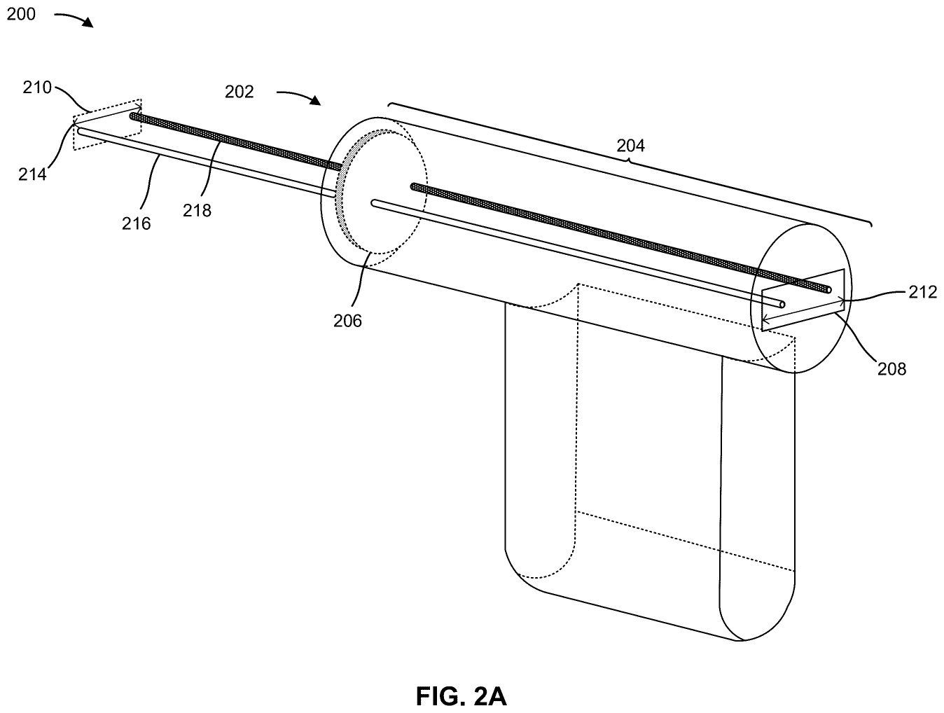

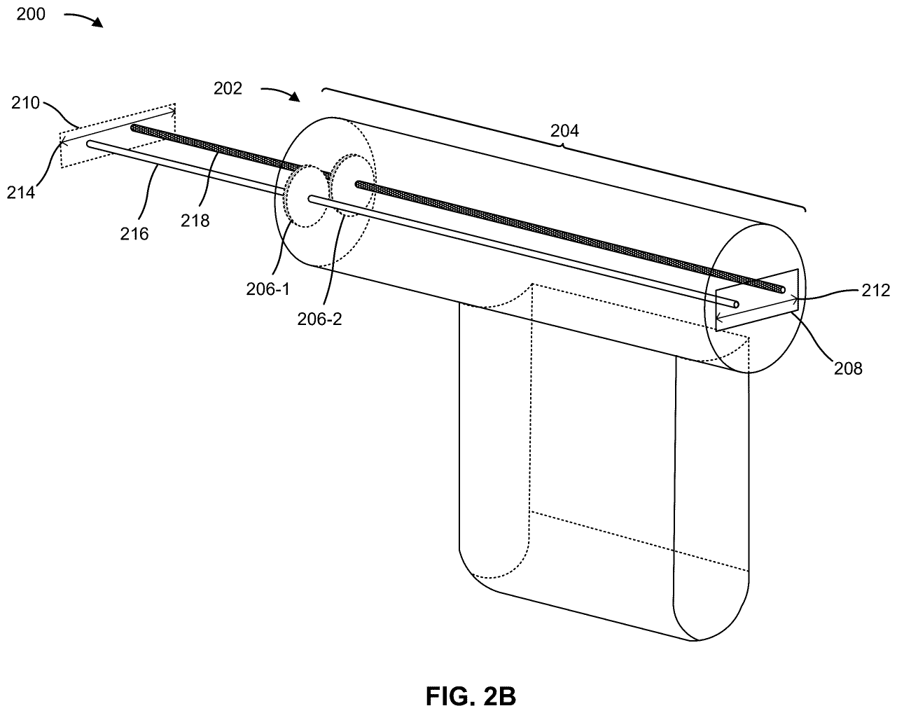

FIGS. 2A-2B are diagrams of one or more example implementations 200 described herein. As shown in FIGS. 2A-2B, example implementation(s) 200 include a device 202 (e.g., a device for inspecting the optical connector 106 and/or the set of one or more optical fibers 104). The device 202 may include one or more components to capture and/or analyze an image or video of an end face of an optical fiber 104, of the set of one or more optical fibers 104, included in the optical cable 102 and the optical connector 106 (e.g., when the optical connector 106 is connected to the optical cable 102), and/or a structural feature 110 of the optical connector 106. For example, the device 202 may include (e.g., housed within the device 202) one or more optical components, such as a microscope 204 that includes one or more lenses 206 and a sensor 208 (e.g., a camera sensor 208).

Each lens 206 may comprise glass, a polymer, or another type of material configured to collect and focus light. Each lens 206 may have a particular magnification power, or a range of magnification powers. FIG. 2A shows an example single-lens configuration of the microscope 204 (e.g., with a single lens 206), FIG. 2B shows an example multiple-lens configuration of the microscope 204 (e.g., with lenses 206-1 and 206-2).

The sensor 208 may include an image sensor such as a charge-coupled device (CCD) sensor, a complementary metal-oxide semiconductor (CMOS) sensor, and/or another type of image sensor. The sensor 208 may convert light (e.g., that is directed to the sensor 208 by the one or more lenses 206) into image data. The image data may include, for example, one or more images (e.g., as single, standalone images, or as a continuous stream of images associated with video) or other image information related to a subject in an FOV 210 of the microscope 204. The sensor 208 may be anisotropic and therefore have a major dimension 212 (e.g., a dimension that is greater than another dimension of the sensor 208). For example, as shown in FIGS. 2A-2B, the major dimension 212 may be a width of the sensor 208.

As shown in FIGS. 2A-2B, the FOV 210 of the microscope 204 may be anisotropic (e.g., because the sensor 208 is anisotropic). Accordingly, the FOV 210 may have a major dimension 214 (e.g., a dimension that is greater than another dimension of the FOV 210). For example, as shown in FIGS. 2A-2B, the major dimension 214 may be a width of the FOV 210. In some implementations, the microscope 204 is configured to have the FOV 210 such that the major dimension 214 of the FOV 210 is aligned with (e.g., parallel to, within a tolerance, such as 1 or 2 degrees) the major dimension 212 of the sensor 208. In some implementations, the microscope 204 may be configured to translate in a direction that is parallel to the major dimension 214 of the FOV 210 (and, thus, also the major dimension 212 of the sensor 208), which extends the FOV 210 along the major dimension 214, such as shown in FIG. 2B. The FOV 210 is therefore sometimes referred to as a net FOV or an extended FOV.

FIGS. 2A and 2B further show example propagation paths of light beams 216 and 218 that originate within the FOV 210 of the microscope 204. The light beam 216 originates closer to a first end (e.g., a left end) of the major dimension 214 of the FOV 210 than a second end (e.g., a right end) of the major dimension 214 and propagates via the one or more lenses 206 to a region of the sensor 208 that is closer to a first end (e.g., a left end) of the major dimension 212 of the sensor 208 than a second end (e.g., a right end) of the major dimension 212. Moreover, the light beam 218 originates closer to the second end (e.g., the right end) of the major dimension 214 than the first end (e.g., the left end) of the major dimension 214 and propagates via the one or more lenses 206 to a region of the sensor 208 that is closer to the second end (e.g., the right end) of the major dimension 212 than the first end (e.g., the left end) of the major dimension 212.

As indicated above, FIGS. 2A-2B are provided as one or more examples. Other examples may differ from what is described with regard to FIGS. 2A-2B. In practice, there may be additional components, fewer components, different components, or differently arranged components than those shown in FIGS. 2A-2B.

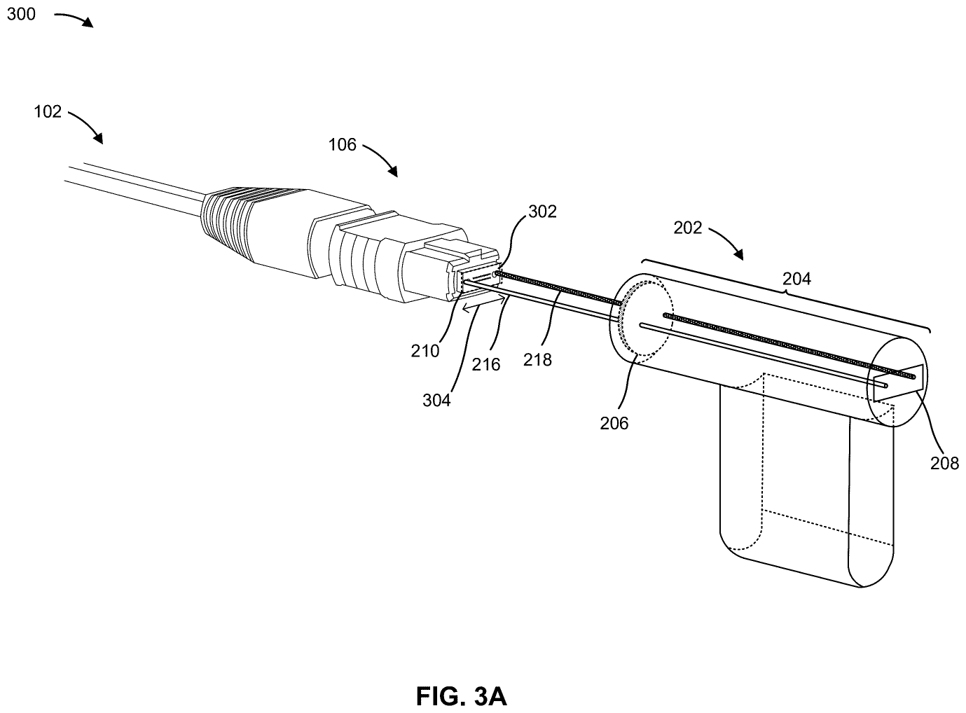

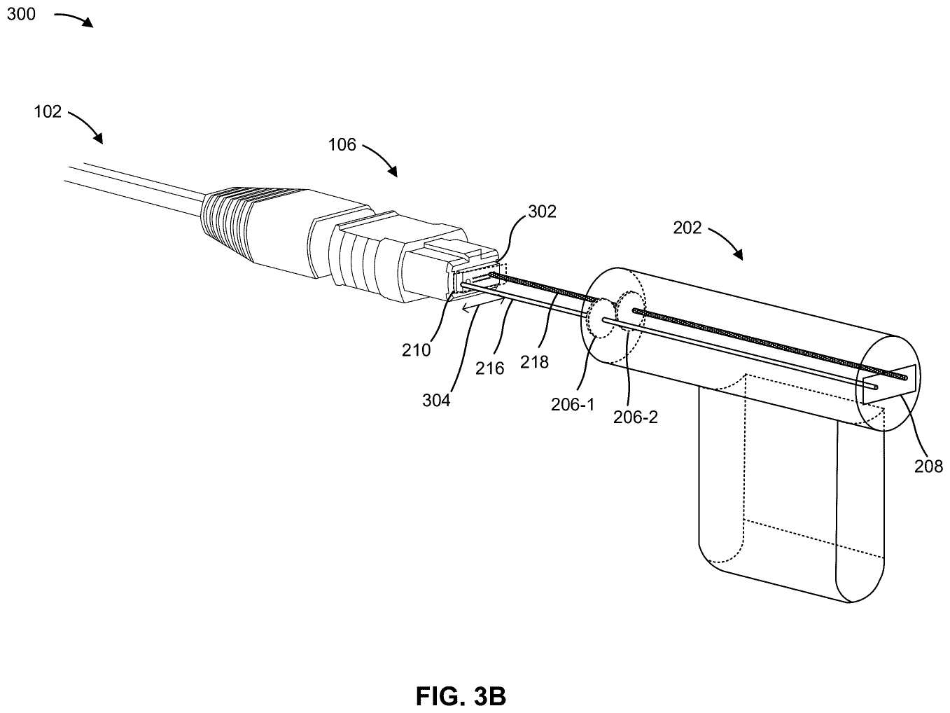

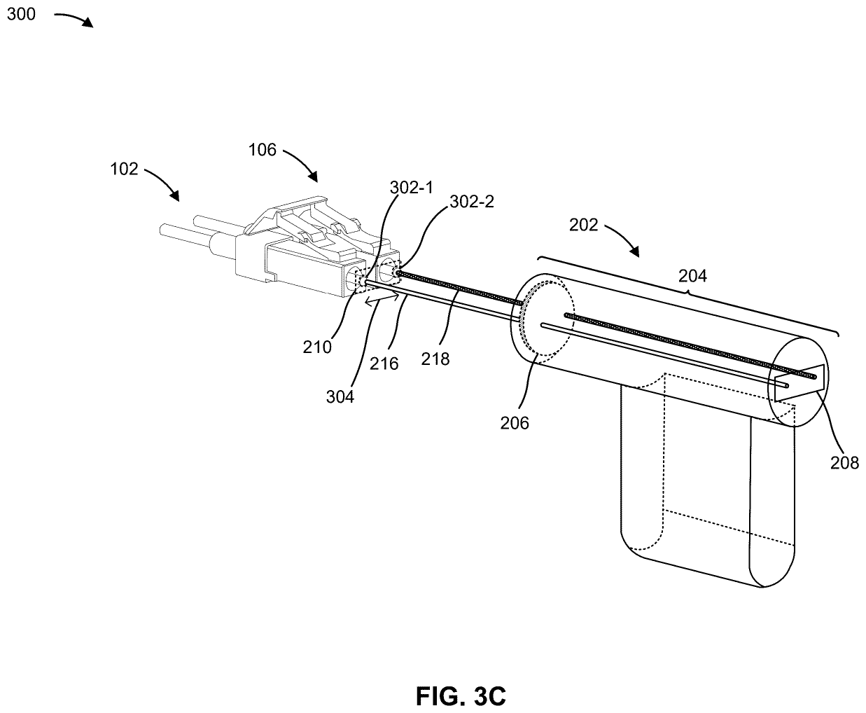

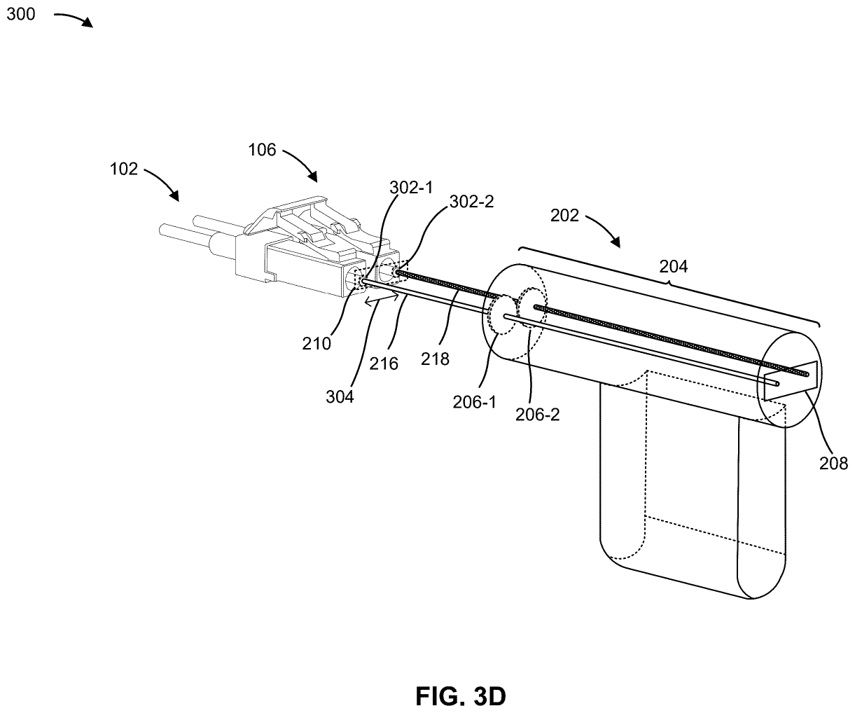

FIGS. 3A-3D are diagrams of one or more example implementations 300 described herein. FIGS. 3A-3D show different configurations of the device 202 inspecting the optical connector 106, which is attached to the optical cable 102, such as when the microscope 204 of the device 202 is configured to inspect at least one ROI 302 of the optical connector 106.

FIG. 3A shows the device 202, with a single-lens configuration of the microscope 204, inspecting the optical connector 106 (shown as an MPO connector). In this case, an ROI 302 of the optical connector 106 includes a front face (e.g., an entirety of the front face) of the optical connector 106 that is associated with the ferrule 108 of the optical connector 106. For example, the ROI 302 may include the set of one or more optical fibers 104 that are held by the ferrule 108 and the one or more structural features 110 of the optical connector 106 that are part of or otherwise associated with the ferrule 108 (see FIG. 1A). As further shown in FIG. 3A, because the ROI 302 is oriented similarly to the FOV 210 of the microscope 204 of the device 202, the ROI 302 is within (e.g., entirely within) the FOV 210 and therefore the light beams 216 and 218 that originate from the ROI 302 propagate, via the lens 206 of the microscope 204, to the sensor 208 of the microscope 204. FIG. 3B shows a similar configuration as FIG. 3A, where the device 202 includes a multiple-lens configuration of the microscope 204.

FIG. 3C shows the device 202, with a single-lens configuration of the microscope 204, inspecting the optical connector 106 (shown as an LC duplex connector). In this case, a plurality of ROIs 302 (shown as ROIs 302-1 and 302-2) are respectively associated with a plurality of ferrules 108 (and a plurality of optical fibers 104) of the optical connector 106 (see FIG. 1B). As further shown in FIG. 3C, because the ROIs 302 are arranged in a line that aligns with the major dimension 214 of the FOV 210 of the microscope 204 of the device 202, the ROIs 302 are within (e.g., entirely within) the FOV 210 and therefore the light beams 216 and 218 that originate from the ROIs 302 propagate, via the lens 206 of the microscope 204, to the sensor 208 of the microscope 204. FIG. 3D shows a similar configuration as FIG. 3C, where the device 202 includes a multiple-lens configuration of the microscope 204.

Accordingly, the optical connector 106 may include an ROI 302 that spans a longest dimension 304 associated with the ROI 302. For example, as shown in FIGS. 3A-3B, the longest dimension 304 may be a width of the ROI 302. Alternatively, the optical connector 106 may include a plurality of ROIs 302 that a span a longest dimension 304 associated with the plurality of ROIs 302. For example, as shown in FIGS. 3C-3D, the longest dimension 304 may be a distance (e.g., in a “width” direction) between the ROIs 302-1 and 302-2. Thus, the longest dimension 304 may be an actual dimension of an ROI 302, or may be a distance between two ROIs 302, along with other examples.

As indicated above, FIGS. 3A-3D are provided as one or more examples. Other examples may differ from what is described with regard to FIGS. 3A-3D. In practice, there may be additional components, fewer components, different components, or differently arranged components than those shown in FIGS. 3A-3D.

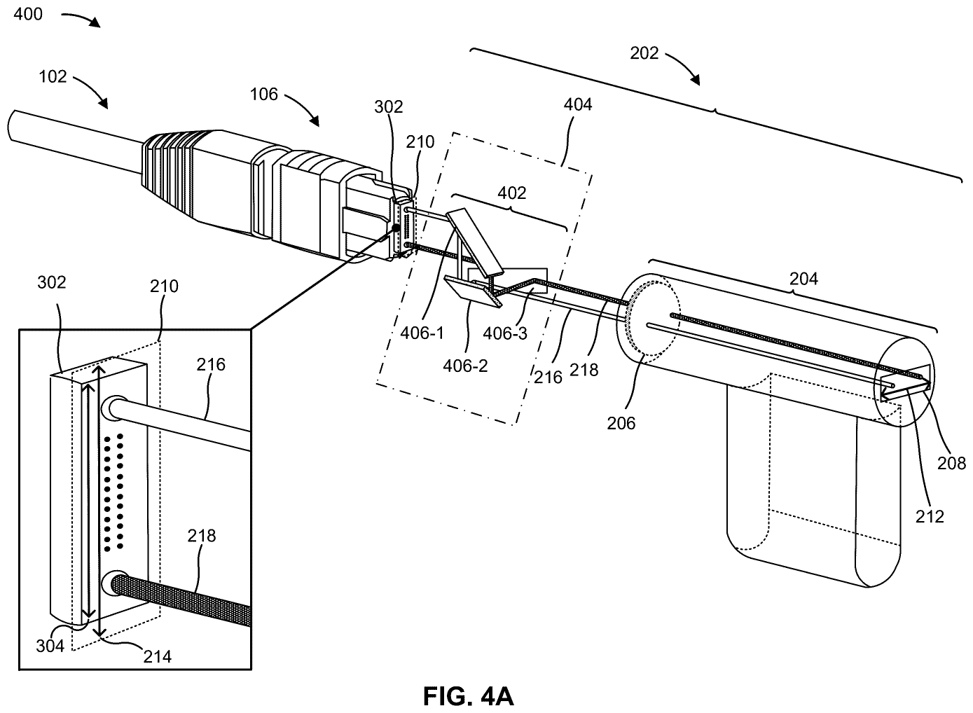

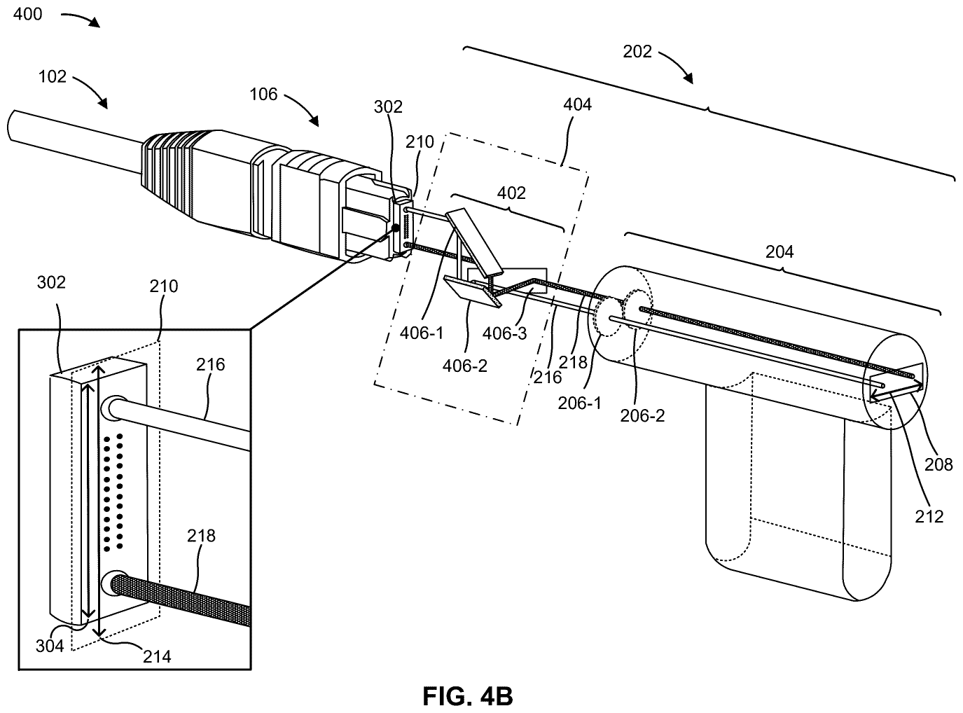

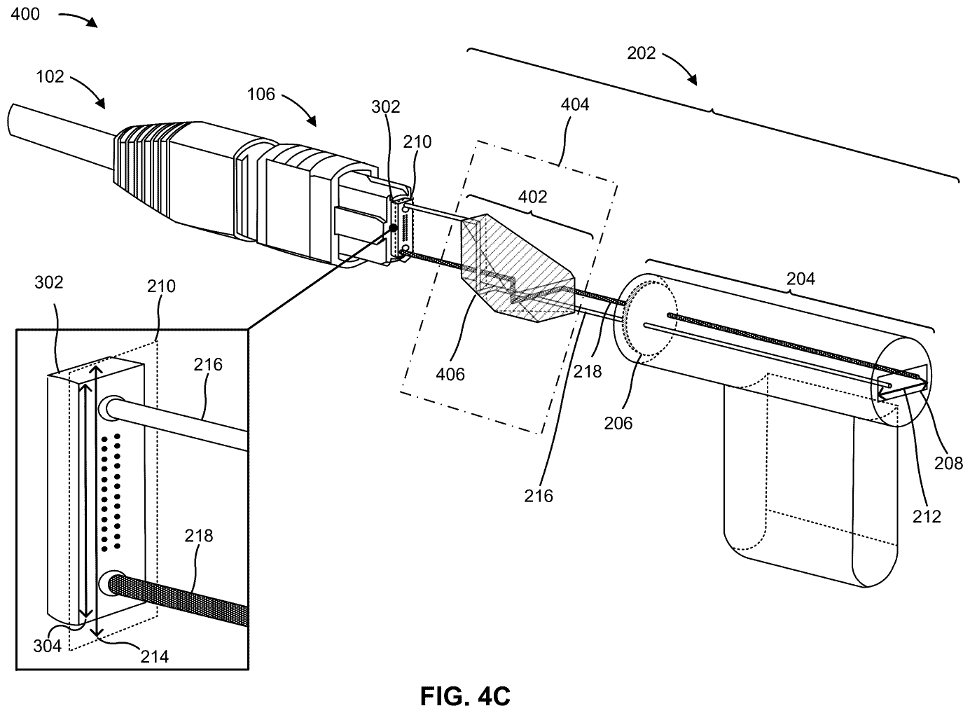

FIGS. 4A-4C are diagrams of one or more example implementations 400 described herein. FIGS. 4A-4C show different configurations of the device 202 inspecting the optical connector 106, which is attached to the optical cable 102, such as when the microscope 204 of the device 202 is configured to inspect at least one ROI 302 of the optical connector 106. FIGS. 4A and 4C show different configurations of the device 202, with a single-lens configuration of the microscope 204, inspecting the optical connector 106 (shown as an MPO connector with a single ROI 302), FIG. 4B shows the device 202, with a multiple-lens configuration of the microscope 204, inspecting the optical connector 106 (shown as an MPO connector with a single ROI 302).

As further shown in FIGS. 4A-4C, the example implementation(s) 400 include an optical system 402, which may be configured to be positioned between the microscope 204 of the device 202 and the ROI 302 of the optical connector 106. In some implementations, the optical system 402 is included in an optical tip 404, or other type of housing or structure, which may interface with the microscope 204 or with another component of the device 202. In some implementations, the optical tip 404 may be an independent component (e.g., that can be attached or unattached based on needs of an operator of the device 202), or may be an integrated part of the device 202. That is, in some implementations, the device 202 may include the optical tip 404, which may include the optical system 402. Additionally, in some implementations, the optical tip 404 may be a stand-alone component, which can be connected to the device 202 and also disconnected from the device 202.

The optical system 402 may comprise a set of optical components 406 (e.g., a set of one or more optical components 406), shown in FIGS. 4A-4B as optical components 406-1 through 406-3 and in FIG. 4C as a single optical component 406. The set of optical components 406 may be configured to reorient the major dimension 214 of the FOV 210. That is, the set of optical components 406 may be configured to reorient the major dimension 214 of the FOV 210 to not align with (e.g., to not be parallel to) the major dimension 212 of the sensor 208. As an example, the set of optical components 406 may be configured to reorient the major dimension 214 of the FOV 210 such that an angle difference between the major dimension 214 of the FOV 210, as reoriented by the set of optical components 406, and the major dimension 212 of the sensor 208 satisfies (e.g., is greater than or equal to) an angle threshold, such as 30 degrees, 45 degrees, 60 degrees, 75 degrees, or 90 degrees, along with other examples associated with enabling a different positioning of the device 202 to improve ergonomics or mitigate physical constraints associated with operation of the device 202.

The set of optical components 406 may be configured to, when the microscope 204 inspects the ROI 302 of the optical connector 106, reorient the major dimension 214 of the FOV 210 to align with the longest dimension 304 associated with the ROI 302 (e.g., that is not aligned with the major dimension 212 of the sensor 208). Accordingly, as further shown in FIGS. 4A-4C, the set of optical components 406 may be configured to (e.g., when the optical connector 106 includes an ROI 302 that spans the longest dimension 304) to direct light that originates from the ROI 302 (e.g., within the reoriented FOV 210) to the sensor 208 of the microscope 204 such that the light aligns with the major dimension 212 of the sensor 208. In this way, the set of optical components 406 enable imaging (e.g., simultaneous imaging) of the entire ROI 302 as a result of the ROI 302 being within the FOV 210 (e.g., as reoriented by the set of optical components 406). For example, as shown in FIGS. 4A-4C, the light beams 216 and 218 originate from the ROI 302, within the FOV 210, and propagate, via the set of optical components 406 and the one or more lenses 206 of the microscope 204, to the sensor 208 of the microscope 204. The light beam 216 originates closer to a first end (e.g., a top end) of the major dimension 214 of the FOV 210 than a second end (e.g., a bottom end) of the major dimension 214 and propagates via the set of optical components 406 and the one or more lenses 206 to a region of the sensor 208 that is closer to a first end (e.g., a left end) of the major dimension 212 of the sensor 208 than a second end (e.g., a right end) of the major dimension 212. Moreover, the light beam 218 originates closer to the second end (e.g., the bottom end) of the major dimension 214 than the first end (e.g., the top end) of the major dimension 214 and propagates via the set of optical components 406 and the one or more lenses 206 to a region of the sensor 208 that is closer to the second end (e.g., the right end) of the major dimension 212 than the first end (e.g., the left end) of the major dimension 212.

The set of optical components 406 may include any type of optical component that alters a light path of light that originates in the FOV 210 of the microscope 204 and propagates to the sensor 208 of the microscope 204. The set of optical components 406 may include, for example, one or more of a reflector, such as a reflector with a selective light reflection characteristic (e.g., that reflects light from particular points or regions of the FOV 210) or a reflector with an extended light reflection characteristic (e.g., that reflects at least a threshold amount of light, such as 50%, of light from the FOV 210, as shown in FIGS. 4A-4B), or a prism (as shown in FIG. 4C).

As indicated above, FIGS. 4A-4C are provided as one or more examples. Other examples may differ from what is described with regard to FIGS. 4A-4C. In practice, there may be additional components, fewer components, different components, or differently arranged components than those shown in FIGS. 4A-4C.

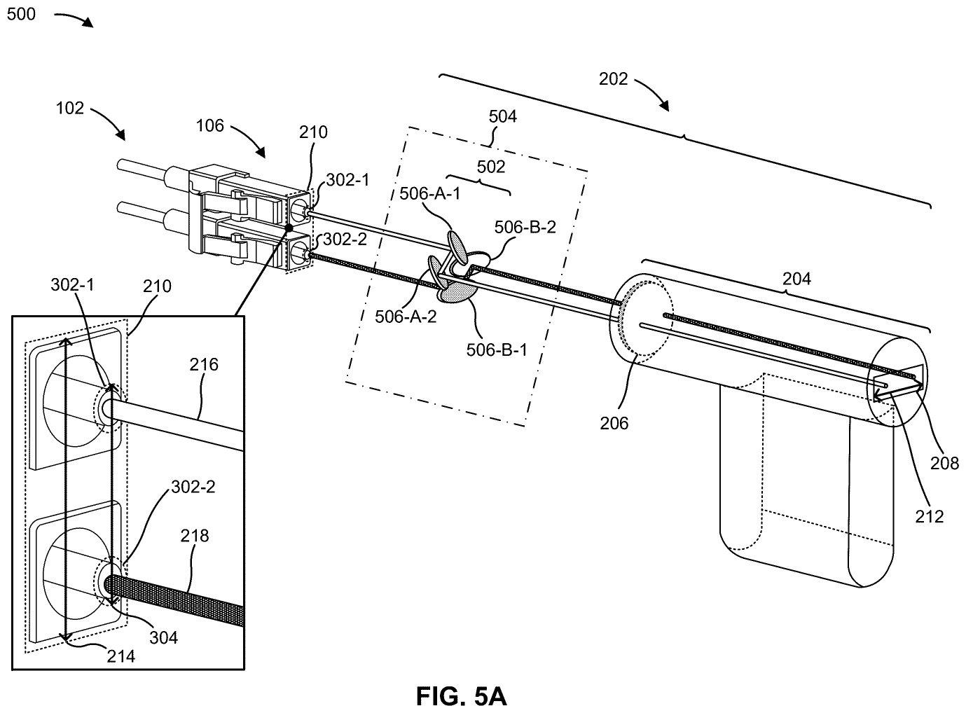

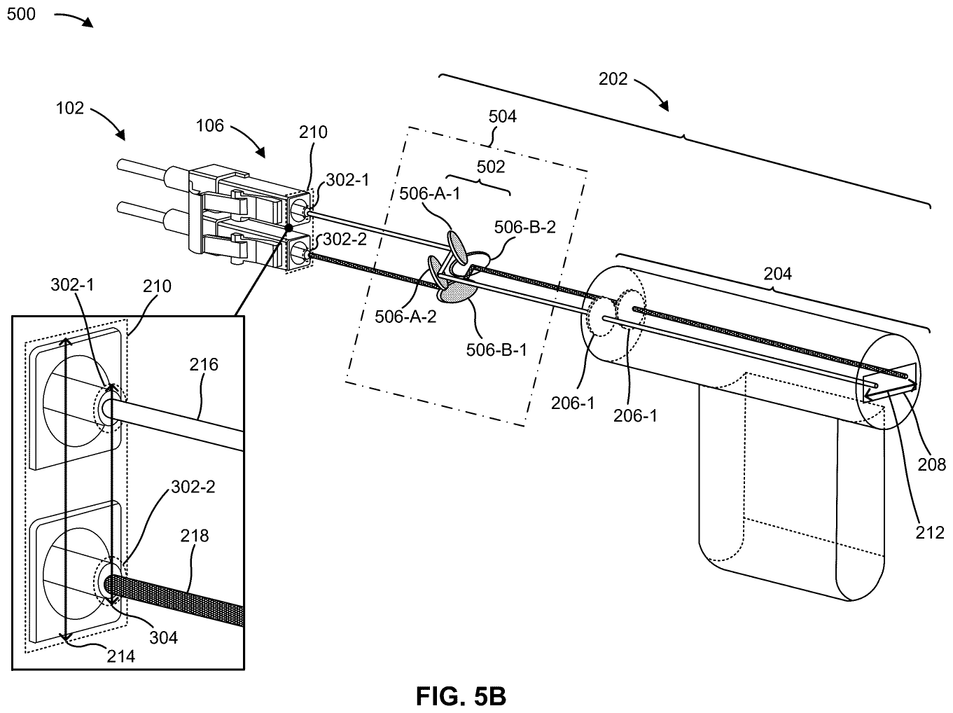

FIGS. 5A-5B are diagrams of one or more example implementations 500 described herein. FIGS. 5A-5B show different configurations of the device 202 inspecting the optical connector 106, which is attached to the optical cable 102, such as when the microscope 204 of the device 202 is configured to inspect at least one ROI 302 of the optical connector 106. FIG. 5A shows the device 202, with a single-lens configuration of the microscope 204, inspecting the optical connector 106 (shown as an LC duplex connector with multiple ROIs 302), FIG. 5B shows the device 202, with a multiple-lens configuration of the microscope 204, inspecting the optical connector 106 (shown as an LC duplex connector with multiple ROIs 302).

As further shown in FIGS. 5A-5B, the example implementation(s) 500 includes an optical system 502, which may be configured to be positioned between the microscope 204 of the device 202 and the multiple ROIs 302 (shown as ROIs 302-1 and 302-2) of the optical connector 106. In some implementations, the optical system 502 is included in an optical tip 504, or other type of housing or structure, which may interface with the microscope 204 or with another component of the device 202, as described elsewhere herein. In some implementations, the optical tip 504 may be an independent component (e.g., that can be attached or unattached based on needs of an operator of the device 202), or may be an integrated part of the device 202. That is, in some implementations, the device 202 may include the optical tip 504, which may include the optical system 502. Additionally, in some implementations, the optical tip 504 may be a stand-alone component, which can be connected to the device 202 and also disconnected from the device 202.

The optical system 502 may comprise a set of optical components 506 (e.g., that comprises respective subsets of optical components 506 associated with the multiple ROIs 302 of the optical connector 106), shown in FIGS. 5A-5B as a first subset of optical components 506-A-1 and 506-A-2 (e.g., that are associated with the ROI 302-1) and a second subset of optical components 506-B-1 and 506-B-2 (e.g., that are associated with the ROI 302-2). The set of optical components 506 may be configured to reorient the major dimension 214 of the FOV 210. That is, the set of optical components 506 may be configured to reorient the major dimension 214 of the FOV 210 to not align with (e.g., to not be parallel to) the major dimension 212 of the sensor 208. As an example, the set of optical components 506 may be configured to reorient the major dimension 214 of the FOV 210 such that an angle difference between the major dimension 214 of the FOV 210, as reoriented by the set of optical components 506, and the major dimension 212 of the sensor 208 satisfies (e.g., is greater than or equal to) an angle threshold, such as 30 degrees, 45 degrees, 60 degrees, 75 degrees, or 90 degrees, along with other examples associated with enabling a different positioning of the device 202 to improve ergonomics or mitigate physical constraints associated with operation of the device 202.

The set of optical components 506 may include respective subsets of optical components 506 that are configured to, when the microscope 204 inspects the multiple ROIs 302 of the optical component 106, reorient the major dimension 214 of the FOV 210 to align with the longest dimension 304 associated with the multiple ROIs 302 (e.g., that is not aligned with the major dimension 212 of the sensor 208). Accordingly, as further shown in FIGS. 5A-5B, the respective subsets of optical components 506 (e.g., the first subset of optical components optical components 506-A and the second subset of optical components 506-B) may be configured to (e.g., when the optical connector 106 includes multiple ROIs 302 that are not coextensive) selectively direct light that originates from the multiple ROIs 302 to sensor 208 of the microscope 204. For example, the respective subsets of optical components 506 may direct only light that originates from the multiple ROIs 302 to the sensor 208. In this way, the respective subsets of optical components 506 enable imaging (e.g., simultaneous imaging) of the multiple ROIs 302 (e.g., only the multiple ROIs 302) as a result of the multiple ROIs 302 being within the FOV 210 (e.g., as reoriented by the respective subsets of optical components 506).

For example, the light beams 216 and 218 originate from the ROI 302, within the FOV 210, and propagate, via the set of optical components 506 and the one or more lenses 206 of the microscope 204, to the sensor 208 of the microscope 204. The light beam 216 originates from the ROI 302-1, which is closer to a first end (e.g., a top end) of the major dimension 214 of the FOV 210 than a second end (e.g., a bottom end) of the major dimension 214, and propagates via the first subset of optical components 506-A-1 and 506-A-2 and the one or more lenses 206 to a region of the sensor 208 that is closer to a first end (e.g., a left end) of the major dimension 212 of the sensor 208 than a second end (e.g., a right end) of the major dimension 212. Moreover, the light beam 218 originates from the ROI 302-1, which is closer to the second end (e.g., the bottom end) of the major dimension 214 than the first end (e.g., the top end) of the major dimension 214, and propagates via the second subset of optical components 506-B-1 and 506-B-2 and the one or more lenses 206 to a region of the sensor 208 that is closer to the second end (e.g., the right end) of the major dimension 212 than the first end (e.g., the left end) of the major dimension 212.

The set of optical components 506 may include any type of optical component that alters a light path of light that originates in the FOV 210 of the microscope 204 and propagates to the sensor 208 of the microscope 204. The set of optical components 506 may include, for example, one or more of a reflector, such as a reflector with a selective light reflection characteristic (e.g., that reflects light from particular points or regions of the FOV 210, as shown in FIGS. 5A-5B) or a reflector with an extended light reflection characteristic (e.g., that reflects at least a threshold amount of light, such as 50%, of light from the FOV 210), or a prism.

As indicated above, FIGS. 5A-5B are provided as one or more examples. Other examples may differ from what is described with regard to FIGS. 5A-5B. In practice, there may be additional components, fewer components, different components, or differently arranged components than those shown in FIGS. 5A-5B.

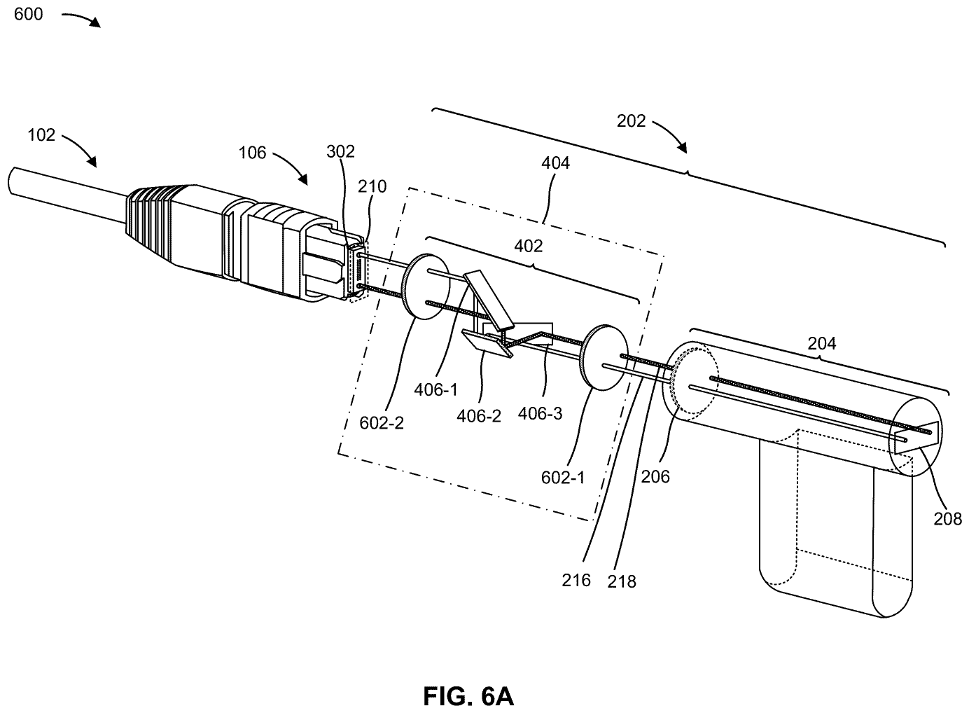

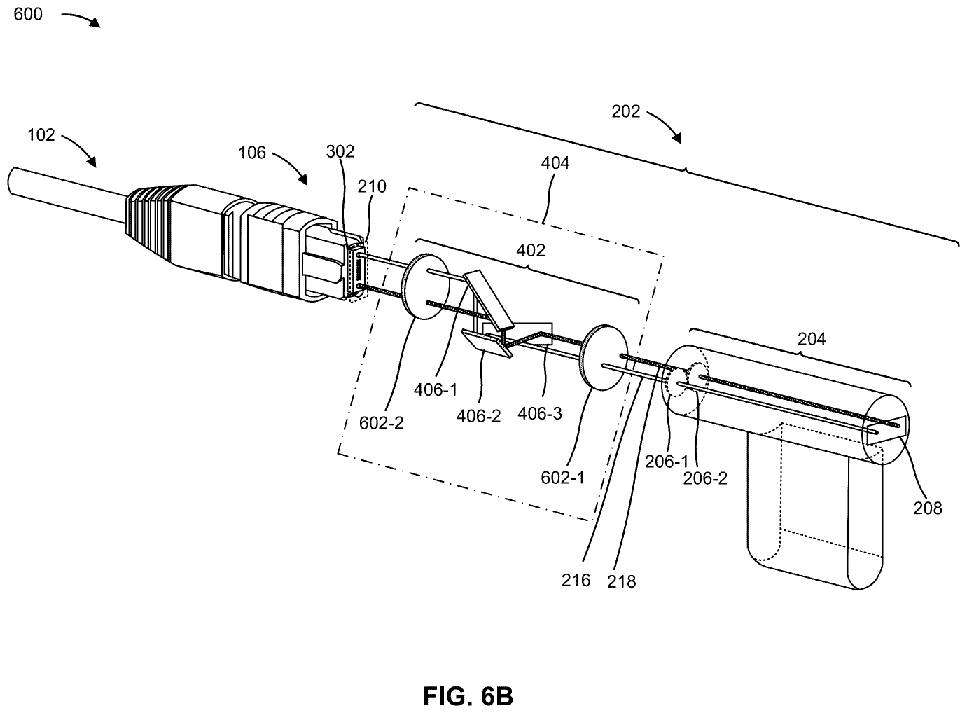

FIGS. 6A-6B are diagrams of one or more example implementations 600 described herein. FIGS. 6A-6B show similar configurations to that shown in FIGS. 4A-4B, where the optical system 402 further includes a set of relay optical components 602. The set of relay optical components 602 may include a first subset of relay optical components 602 that are configured to be positioned between the set of optical components 406 and the microscope 204 and/or a second subset of relay optical components 602 that are configured to be positioned between the set of optical components 406 and the ROI 302 of the optical connector 106. For example, as shown in FIGS. 6A-6B, a first relay optical component 602-1 is positioned between the set of optical components 406 and the microscope 204 and a second relay optical component 602-2 is positioned between the set of optical components 406 and the ROI 302 of the optical connector 106.

The set of relay optical components 602 may include one or more of lenses, mirrors, prisms, or other optical components that are configured to facilitate propagation of light from the ROI 302 to the microscope 204. For example, as shown in FIGS. 6A-B, the set of relay optical components 602 may be configured to extend respective light paths of the light beams 216 and 218.

As indicated above, FIGS. 6A-6B are provided as one or more examples. Other examples may differ from what is described with regard to FIGS. 6A-6B. In practice, there may be additional components, fewer components, different components, or differently arranged components than those shown in FIGS. 6A-6B.

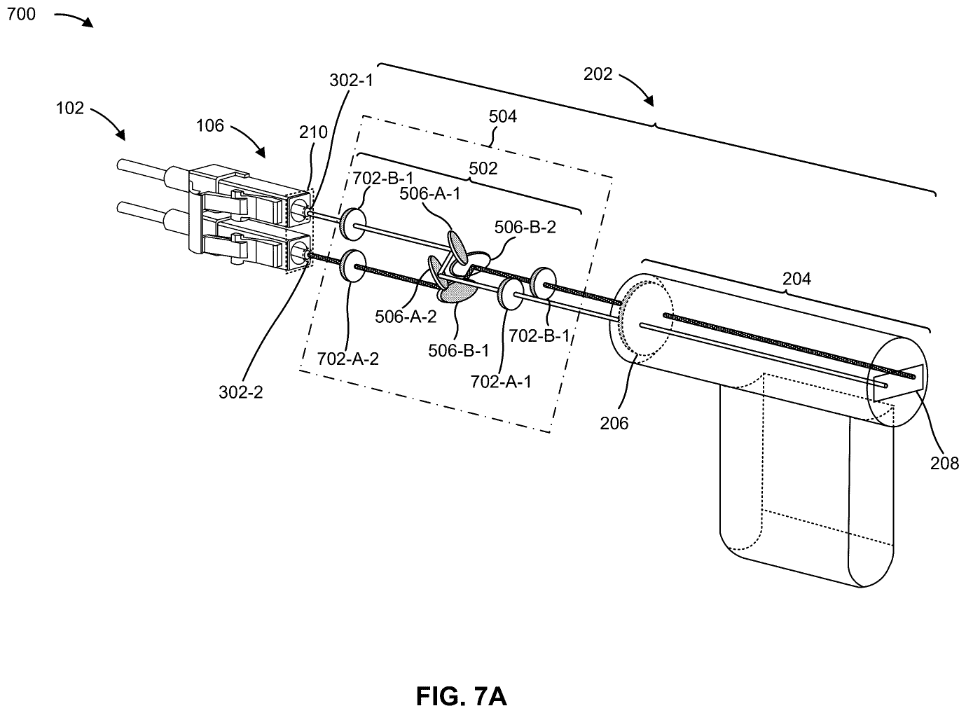

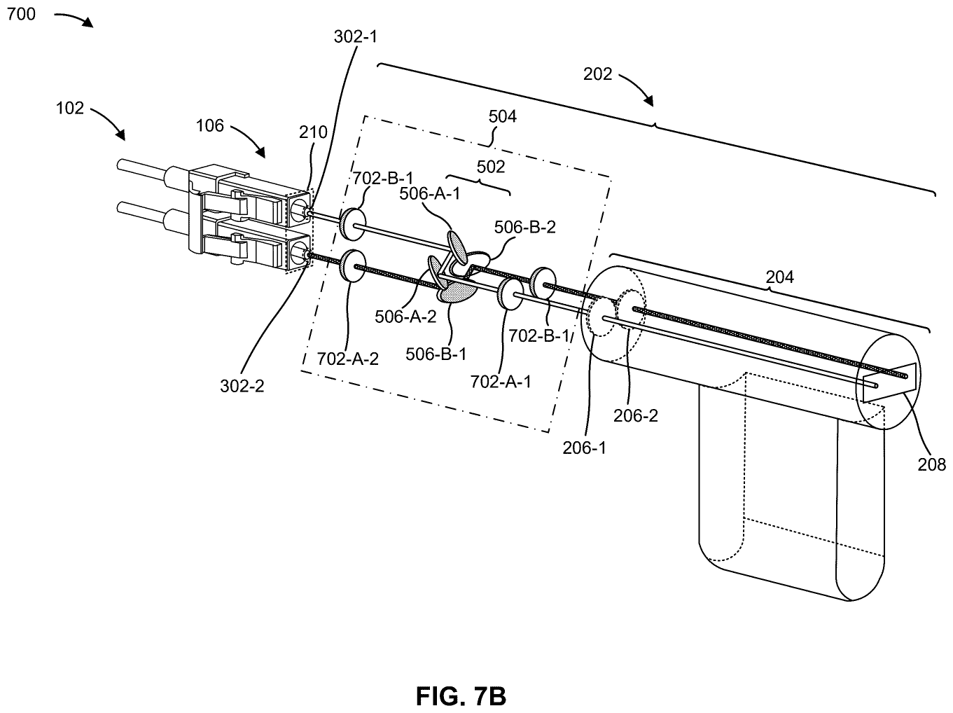

FIGS. 7A-7B are diagrams of one or more example implementations 700 described herein. FIGS. 7A-7B show similar configurations to that shown in FIGS. 5A-5B, where the optical system 502 further includes a set of relay optical components 702. The set of relay optical components 702 may include a first subset of relay optical components 702 that are configured to be positioned between the set of optical components 506 and the microscope 204 and/or a second subset of relay optical components 702 that are configured to be positioned between the set of optical components 506 and the ROIs 302-1 and 302-2 of the optical connector 106. For example, as shown in FIGS. 7A-7B, a first subset of relay optical components 702-A-1 and 702-A-2 are positioned between the set of optical components 506 and the microscope 204 and a second subset of relay optical components 702-B-1 and 702-B-2 are positioned between the set of optical components 406 and the ROIs 302-1 and 302-2 of the optical connector 106.

The set of relay optical components 702 may include one or more of lenses, mirrors, prisms, or other optical components that are configured to facilitate propagation of light from the multiple ROIs 302 to the microscope 204. For example, as shown in FIGS. 7A-7B, the set of relay optical components 702 may be configured to extend respective light paths of the light beams 216 and 218.

As indicated above, FIGS. 7A-7B are provided as one or more examples. Other examples may differ from what is described with regard to FIGS. 7A-7B. In practice, there may be additional components, fewer components, different components, or differently arranged components than those shown in FIGS. 7A-7B.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device for inspecting an optical connector attached to an optical cable, comprising:
a microscope configured to inspect at least one region of interest (ROI) of the optical connector; and
an optical system configured to be positioned between the microscope and the at least one ROI of the optical connector, the optical system including a set of optical components, wherein:
the microscope is configured to have a field of view (FOV) with a first major dimension that is aligned with a second major dimension of a sensor of the microscope; and
the set of optical components are configured to, when the microscope inspects the at least one ROI, reorient the first major dimension of the FOV to align with a longest dimension associated with the at least one ROI that is not aligned with the second major dimension of the sensor.

2. The device of claim 1, wherein the optical system is included within an optical tip of the device, wherein the optical tip interfaces with the microscope.

3. The device of claim 1, wherein the set of optical components includes subsets of optical components that are configured to, when the optical connector includes multiple ROIs, selectively direct light that originates from the multiple ROIs to the sensor of the microscope.

4. The device of claim 1, wherein the set of optical components are configured to, when the optical connector includes an ROI that spans the longest dimension associated with the at least one ROI, direct light that originates from the ROI to the sensor of the microscope such that the light aligns with the second major dimension of the sensor.

5. The device of claim 1, wherein the set of optical components includes one or more of:
a reflector with a selective light reflection characteristic,
a reflector with an extended light reflection characteristic, or
a prism.

6. The device of claim 1, where the optical system further includes a set of relay optical components that include at least one of:
a first subset of relay optical components that are configured to be positioned between the set of optical components and the microscope, or
a second subset of relay optical components that are configured to be positioned between the set of optical components and the at least one ROI of the optical connector.

7. The device of claim 1, wherein the optical connector includes one of:
a fiber-optic connector (FC),
an FC/physical content connector,
an FC/angled physical content connector,
a snap-in connector,
a straight tip connector,
a multiple fiber push-on/pull-off connector, or
a little connector duplex connector.

8. The device of claim 1, wherein an angle difference between the longest dimension associated with the at least one ROI and the second major dimension of the sensor is greater than or equal to 30 degrees.

9. A device for inspecting an optical connector attached to an optical cable, comprising:
a microscope; and
an optical system that includes a set of optical components, wherein:
the microscope is configured to have a field of view (FOV) with a first major dimension that is aligned with a second major dimension of a sensor of the microscope; and
the set of optical components are configured to reorient the first major dimension of the FOV to not align with the second major dimension of the sensor.

10. The device of claim 9, wherein the optical system is included within an optical tip of the device, wherein the optical tip interfaces with the microscope.

11. The device of claim 9, wherein the set of optical components are further configured to, when the microscope inspects at least one region of interest (ROI) of the optical connector, reorient the first major dimension of the FOV to align with a longest dimension associated with the at least one ROI.

12. The device of claim 11, wherein the set of optical components are configured to, when the optical connector includes multiple ROIs, selectively direct light that originates from the multiple ROIs to the sensor of the microscope.

13. The device of claim 11, wherein the set of optical components are configured to, when the optical connector includes an ROI that spans the longest dimension associated with the at least one ROI, direct light that originates from the ROI to the sensor of the microscope such that the light aligns with the second major dimension of the sensor.

14. The device of claim 9, wherein the set of optical components includes one or more of:
a reflector with a selective light reflection characteristic,
a reflector with an extended light reflection characteristic, or
a prism.

15. The device of claim 9, where the optical system further includes a set of relay optical components.

16. The device of claim 9, wherein an angle difference between the first major dimension of the FOV, as reoriented by the set of optical components, and the second major dimension of the sensor is greater than or equal to 30 degrees.

17. An optical tip, comprising:
an optical system that includes a set of optical components, wherein:
the optical tip is configured to interface with a device that includes a microscope that is configured to inspect an optical connector attached to an optical cable; and
the set of optical components are configured to reorient a first major dimension of a field of view (FOV) of the microscope of the device to not align with a second major dimension of a sensor of the device.

18. The optical tip of claim 17, wherein the set of optical components are further configured to, when the microscope of the device inspects at least one region of interest (ROI) of the optical connector, reorient the first major dimension of the FOV to align with a longest dimension associated with the at least one ROI.

19. The optical tip of claim 17, wherein the set of optical components includes one or more of:
a reflector with a selective light reflection characteristic,
a reflector with an extended light reflection characteristic, or
a prism.

20. The optical tip of claim 17, where the optical system further includes a set of relay optical components.
